(19) United States
(12) Patent Application Publication
(10) Pub. No.: US 2013/0157676 A1
(43) Pub. Date: Jun. 20, 2013

(54) CONTROL METHOD FOR DEVICE-TO-DEVICE COMMUNICATION

(71) Applicant: Electronics and Telecommunications Research Institute, Daejeon (KR)

(72) Inventors: Seung Kwon BAEK, Daejeon (KR); Dae Ho KIM, Daejeon (KR); Nam Hoon PARK, Daejeon (KR)

(73) Assignee: Electronics and Telecommunications Research Institute, Daejeon (KR)

(21) Appl. No.: 13/713,566

(22) Filed: Dec. 13, 2012

(30) Foreign Application Priority Data
Dec. 14, 2011 (KR) 10-2011-0134789

(51) Int. Cl. H04W 72/04

(52) U.S. Cl. CPC H04W 72/0486
USPC 455/452.1

(57) ABSTRACT

Provided is a control method for device-to-device (D2D) communication. A base station measures a load of a cell, receives location information about each piece of user equipment (UE) from a plurality of pieces of UE, selects any one of an overlay-based resource allocation method and an underlay-based resource allocation method on the basis of the measured cell load and the location information about the respective pieces of UE, allocates resources for D2D communication on the basis of the selected resource allocation method, and controls power according to the locations of the pieces of UE and a density of pieces of cellular communication UE. Accordingly, it is possible to improve resource use efficiency and efficiently remove interference.

### CLAIM FOR PRIORITY

This application claims priority to Korean Patent Application No. 10-2011-0134789 filed on Dec. 14, 2011 in the Korean Intellectual Property Office (KIPO), the entire contents of which are hereby incorporated by reference.

### BACKGROUND

1. Technical Field

Example embodiments of the present invention relate in general to device-to-device (D2D) communication, and more particularly, to a control method for D2D communication capable of efficiently allocating resources for D2D communication and dynamically controlling transmission power in D2D communication.

2. Related Art

Recently, with the proliferation of various smart user equipment (UE), data traffic has remarkably increased. Since an increase in the users of smart UE will further activate various multimedia services, data traffic is expected to more rapidly increase in the future.

In particular, future communication services will include not only conventional communication between persons but also intelligent communication using a machine such as communication between a person and a machine, between machines, etc., and thus it is expected that base stations will be inundated with traffic that should be handled by the base stations. Such a sharp increase in communication traffic causes considerable problems such as network capacity, data transmission rates, and service quality. As a method for solving these problems, D2D communication is considered in a next-generation mobile communication system such as Third Generation Partnership Project (3GPP) Long Term Evolution (LTE) or LTE-Advanced.

In a cellular mobile communication system, D2D communication denotes a communication method in which pieces of UE present in the same cell or adjacent cells set a communication link between themselves and then directly exchange data through the set communication link via no base station. In other words, in D2D communication, two adjacent pieces of UE set a D2D communication link using resources for cellular mobile communication and then perform communication using the D2D communication link via no base station.

For D2D communication, a base station should manage radio resources and a transmission state for a D2D communication link on the basis of radio resource management for cellular communication. To this end, the base station constantly exchanges control signals with UE to analyze the D2D communication link and the D2D communication state, and controls the D2D communication using the analysis information.

In related art, pieces of mobiles communication UE that want to communicate with each other should perform communication via a mobile communication base station although the pieces of mobile communication UE are geographically adjacent to each other. On the other hand, D2D communication allows direct data exchange between pieces of mobile communication UE, and thus can reduce signal procedures of a base station. In addition, since geographically adjacent pieces of UE perform direct communication, power consumptions of the pieces of D2D UE can be reduced, and data transmission rates of the pieces of UE can be increased. Furthermore, D2D communication can increase an accommodation capability of a cellular network and expand a cell area.

Meanwhile, to support D2D communication in a cellular mobile communication system, there is a necessity of solving problems such as determination of whether or not to perform D2D communication between pieces of UE, interference between a D2D communication signal and a cellular communication signal caused by reuse of cellular frequency resources, resource allocation for D2D communication, billing, error checking, and so on.

### SUMMARY

Accordingly, example embodiments of the present invention are provided to substantially obviate one or more problems due to limitations and disadvantages of the related art.

Example embodiments of the present invention provide a control method for device-to-device (D2D) communication capable of efficiently allocating resources for D2D communication, and dynamically controlling transmission power of pieces of user equipment (UE) that perform D2D communication.

In some example embodiments, a D2D communication control method is a resource allocation method for D2D communication performed in a base station, and includes: measuring a load of a cell; receiving location information about each piece of UE from a plurality of pieces of UE; selecting any one of an overlay-based resource allocation method and an underlay-based resource allocation method on the basis of the measured cell load and the location information about the respective pieces of UE; and allocating resources for D2D communication on the basis of the selected resource allocation method.

Here, receiving location information about each piece of UE from the plurality of pieces of UE may include: transmitting a message requesting setup of a D2D communication link to the plurality of pieces of UE; and receiving the location information from the respective pieces of UE receiving the message requesting setup of a D2D communication link.

Here, selecting any one resource allocation method may include: determining whether pieces of UE between which a D2D communication link will be set among the plurality of pieces of UE are present in the same cell on the basis of the received location information about the respective pieces of UE; and selecting the underlay-based resource allocation method when the pieces of UE between which a D2D communication link will be set are present in the same cell, and the measured cell load is a predetermined reference value or more, and selecting the overlay-based resource allocation method when the pieces of UE between which a D2D communication link will be set are present in the same cell, and the measured cell load is less than the predetermined reference value.

Here, selecting any one resource allocation method may include: determining whether pieces of UE between which a D2D communication link will be set among the plurality of pieces of UE are present in the same cell on the basis of the received location information about the respective pieces of UE; when the pieces of UE between which a D2D communication link will be set are respectively present in a first cell and a second cell different from each other, exchanging, at a first base station managing the first cell and a second base station managing the second cell, load information about the first and second cells managed by the first and second base stations; and selecting, at each of the first and second base stations, the overlay-based resource allocation method when the loads of the first and second cells are less than a predetermined reference value, and selecting the underlay-based resource allocation method when any one of the loads of the first and second cells is the predetermined reference value or more.

In other example embodiments, a method of controlling D2D communication between first piece of UE present in a first cell and second piece of UE present in a second cell includes: measuring, at each of a first base station managing the first cell and a second base station managing the second cell, a cell load of the base station; exchanging, at the first base station and the second base station, the cell load information for D2D communication; selecting, at each of the first base station and the second base station, any one of an overlay-based resource allocation method and an underlay-based resource allocation method on the basis of the measured cell load of the base station; and allocating, at each of the first base station and the second base station, resources on the basis of the selected resource allocation method.

Here, selecting any one resource allocation method may include selecting, at each of the first base station and the second base station, the overlay-based resource allocation method when the loads of the first and second cells are less than a predetermined reference value, and selecting, at each of the first base station and the second base station, the underlay-based resource allocation method when any one of the loads of the first and second cells is the predetermined reference value or more.

In other example embodiments, a D2D communication control method performed in a base station includes: receiving location information about each piece of UE from a plurality of pieces of UE; performing power control for D2D communication on the basis of the location information about the respective pieces of UE; and transmitting power control information to pieces of D2D communication UE that are pieces of UE between which a D2D communication link will be set among the plurality of pieces of UE.

Here, performing power control for D2D communication may include differently setting a maximum power threshold according to a distance between locations of the pieces of D2D communication UE and the base station on the basis of the received location information about the respective pieces of UE, and assigning a higher maximum power threshold to pieces of first D2D communication UE whose distance from the base station is a first distance than pieces of second D2D communication UE whose distance from the base station is a second distance greater than the first distance.

Here, performing power control for D2D communication may include differently setting a maximum power threshold according to a density of pieces of cellular communication UE present within a predetermined area centered on the locations of the pieces of D2D communication UE on the basis of the received location information about the respective pieces of UE, and assigning a lower maximum power threshold to pieces of first D2D communication UE whose density is a first density than pieces of second D2D communication UE whose density is a second density lower than the first density.

Here, performing power control for D2D communication may include differently setting a maximum power threshold according to a distance between the locations of the pieces of D2D communication UE and the base station, and a density of pieces of cellular communication UE present within a predetermined area centered on the locations of the pieces of D2D communication UE on the basis of the received location information about the respective pieces of UE.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of device-to-device (D2D) communication performed in a cellular mobile communication system;

FIG. 2 is a conceptual diagram illustrating radio resource allocation methods;

FIG. 3 is a conceptual diagram illustrating a resource allocation method for D2D communication according to an example embodiment of the present invention;

FIG. 4 and FIG. 5 are conceptual diagrams illustrating a resource allocation method for D2D communication according to another example embodiment of the present invention;

FIG. 6 and FIG. 7 are conceptual diagrams illustrating a power control method for D2D communication according to an example embodiment of the present invention;

FIG. 8 is a flowchart illustrating a procedure for performing resource allocation and power control for D2D communication according to an example embodiment of the present invention;

FIG. 9 is a flowchart illustrating a procedure for performing resource allocation and power control for D2D communication according to another example embodiment of the present invention; and

FIG. 10 is a flowchart illustrating operation of a base station that performs a resource allocation and power control method for D2D communication according to example embodiments of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, example embodiments of the present invention will be described in detail with reference to the appended drawings. To aid in understanding the present invention, like numbers refer to like elements throughout the description of the figures, and the description of the same component will not be reiterated.

The term “user equipment (UE)” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), mobile node, mobile, or other terms. Various example embodiments of UE may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

The term “base station” used herein generally denotes a fixed or moving point that communicates with UE, and may be a common name for Node-B, evolved Node-B (eNode-B), base transceiver system (BTS), access point, relay, and so on.

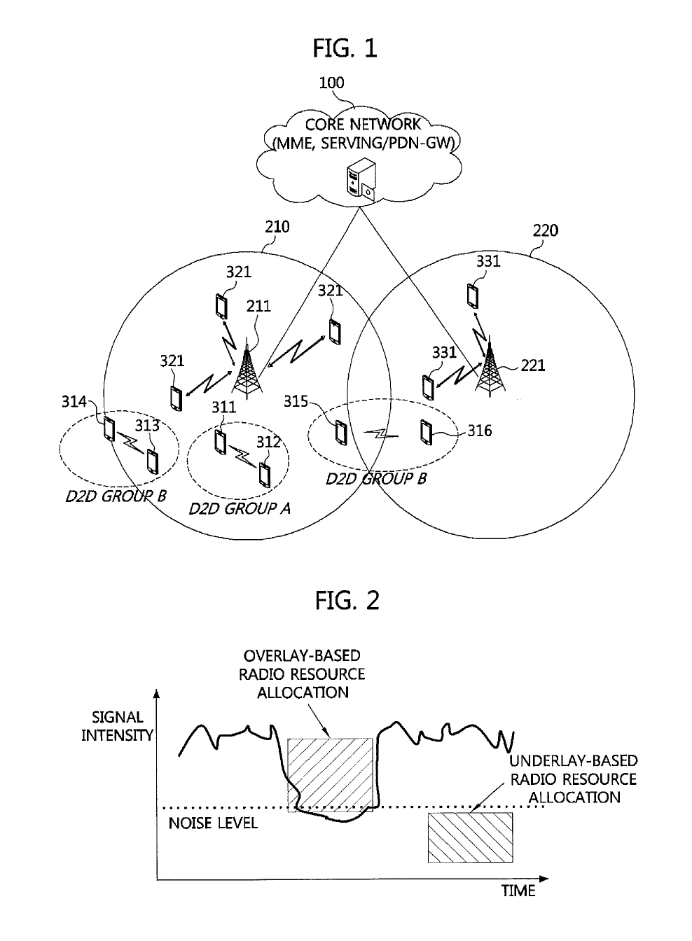

FIG. 1 is a conceptual diagram of device-to-device (D2D) communication performed in a cellular mobile communication system.

Referring to FIG. 1, in a core network (or evolved packet core) 100 of a general cellular mobile communication system, there are a mobility management entity (MME) that is a control plane node performing a bearer management function and a connection management function, and a serving/packet data network (PDN) gateway that is a user plane node performing Internet protocol (IP) address allocation to UE, quality of service (QoS) management, and a user's IP packet transmission. Also, in each cell of a wireless access network, there are a base station that provides a wireless access service to UE and a plurality of pieces of UE provided with the service through the base station.

In the cellular mobile communication system as illustrated in FIG. 1, pieces of UE present in the same cell or pieces of UE present in adjacent cells may perform direct communication with each other via no base station managing each cell, and such a communication form is D2D communication.

In other words, in FIG. 1, D2D communication is performed between a first piece of UE 311 and a second piece of UE 312 present in a first cell 210, and between a third piece of UE 313 and a fourth piece of UE 314 present at a boundary of the first cell 210 not via a first base station 211.

In addition, in FIG. 1, a fifth piece of UE 315 present in the first cell 210 and a sixth piece of UE 316 present at a short distance from the fifth piece of UE 315 in a second cell 220 neighboring the first cell 210 also perform D2D communication not via the first base station 211 and a second base station 221.

Meanwhile, in FIG. 1, pieces of UE 321 present in the first cell 210 perform general cellular communication using the first base station 211, and pieces of UE present in the second cell 220 perform cellular communication using the second base station 221.

For D2D communication as illustrated in FIG. 1, the respective base stations 211 and 221 should perform resource allocation and control.

For convenience, UE performing D2D communication will be referred to as “D2D communication UE” below, and UE performing communication via a base station will be referred to as “cellular communication UE” below.

In general, radio resource allocation methods for a case where a plurality of nodes perform communication using the same resources may be classified as an overlay-based radio resource allocation method and an underlay-based radio resource allocation method.

FIG. 2 is a conceptual diagram illustrating radio resource allocation methods.

Referring to FIG. 2, the overlay-based radio resource allocation method spatially and temporally coordinates the use of radio resources, thereby preventing a collision between different wireless links.

The underlay-based radio resource allocation method is applied to an environment in which radio resources in the same temporal and spatial space are used by a plurality of communication links. In an environment in which communication is performed through a specific wireless link using predetermined radio resources, the underlay-based radio resource allocation method allocates the radio resources to another communication link as long as no fault occurs in communication through the specific wireless link.

In a resource allocation method for D2D communication according to example embodiments of the present invention, the underlay-based radio resource allocation method and the overlay-based radio resource allocation method are adaptively used according to a resource condition of each cell and whether pieces of UE setting a D2D communication link are present in one cell or two cells.

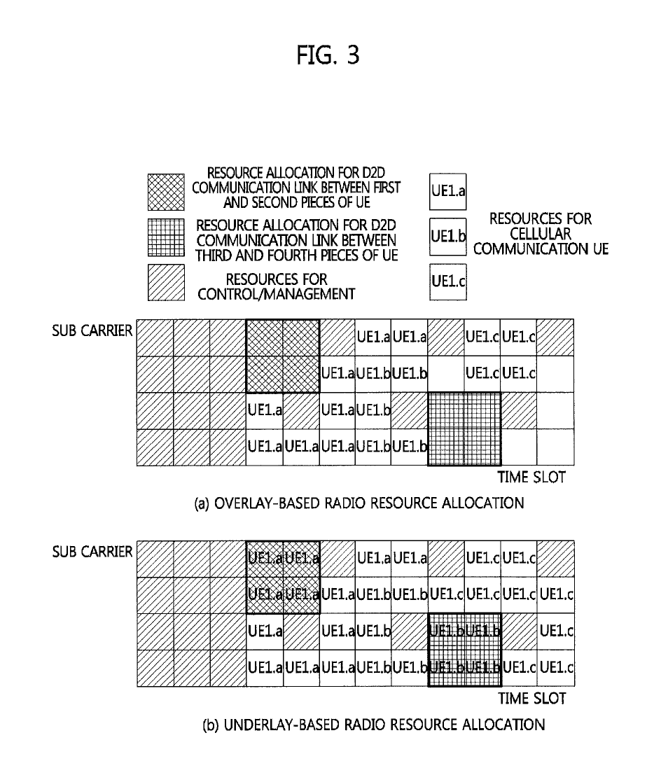

FIG. 3 is a conceptual diagram illustrating a resource allocation method for D2D communication according to an example embodiment of the present invention, that is, a radio resource allocation method for setting a D2D communication link in a single cell. The radio resource allocation method can be applied to the first piece of UE 311, the second piece of UE 312, the third piece of UE 313 and the fourth piece of UE 314 shown in FIG. 1.

In the radio resource allocation method for setting a D2D communication link in a single cell, a base station uses any one of the underlay-based radio resource allocation method and the overlay-based radio resource allocation method according to a load of the cell.

Specifically, the base station allocates radio resources for a D2D communication link using the underlay-based radio resource allocation method when the current load (i.e., load of radio resources) is a predetermined reference or more, and allocates radio resources for a D2D communication link using the overlay-based radio resource allocation method when the current load of the cell is less than the reference.

In other words, in example embodiments of the present invention, a base station exclusively allocates available radio resources to a D2D communication link in a cell when a load of the cell is low and there are the available radio resources, and allocates resources used in cellular communication to the D2D communication link using the underlay-based radio resource allocation method to share the radio resources between a cellular communication link and the D2D communication link when a load of the base station is high and there are not sufficient available resources.

For example, when a load of a cell is low and there are available resources that are not resources allocated to pieces of cellular communication UE as shown in (a) of FIG. 3, a base station allocates the available resources to a D2D communication link between the first piece of UE 311 and the second piece of UE 312 and a D2D communication link between the third piece of UE 313 and the fourth piece of UE 314.

On the other hand, when a load of a cell is high and there are no available resources to be exclusively allocated to a D2D communication link as shown in (b) of FIG. 3, the base station allocates some of resources allocated to pieces of UE that will perform cellular communication to the D2D communication link between the first piece of UE 311 and the second piece of UE 312 and the D2D communication link between the third piece of UE 313 and the fourth piece of UE 314.

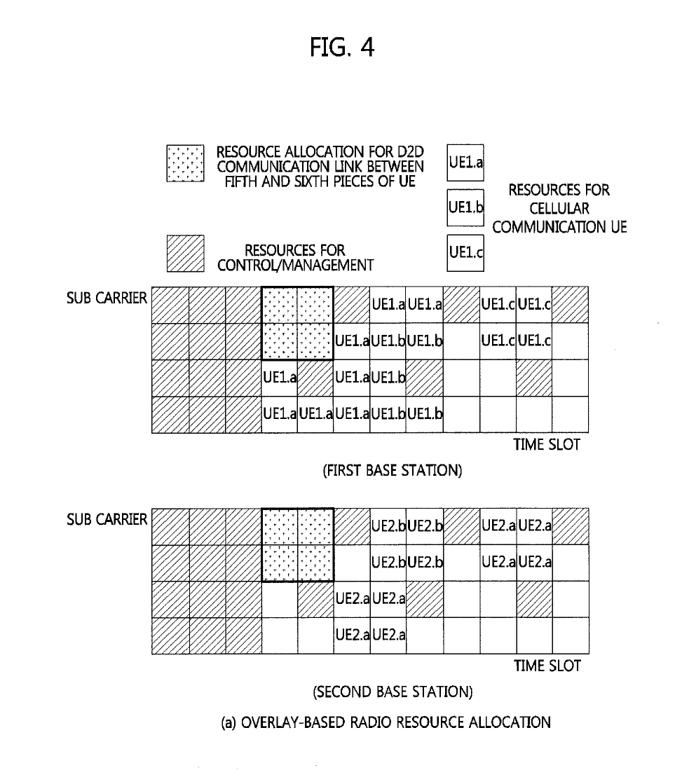

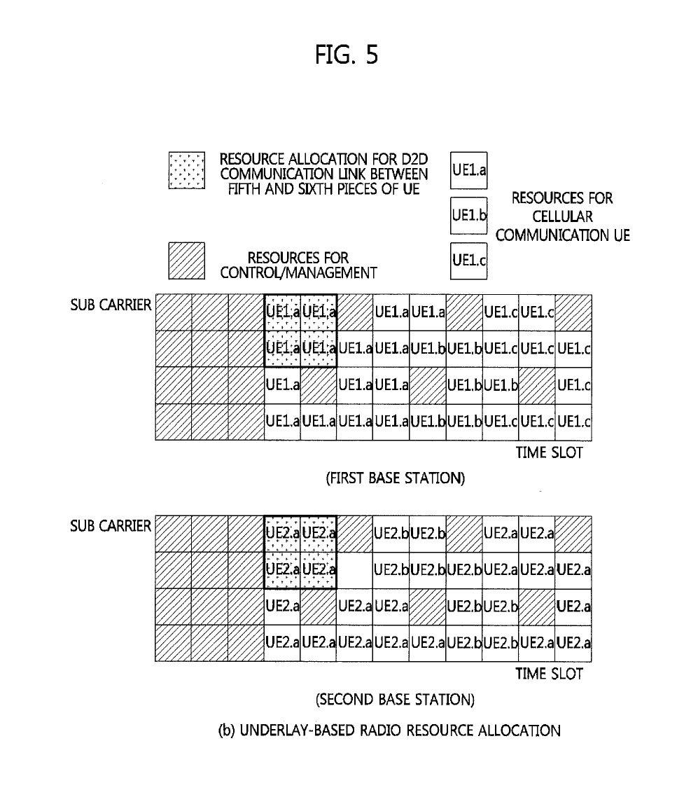

FIG. 4 and FIG. 5 are conceptual diagrams illustrating a resource allocation method for D2D communication according to another example embodiment of the present invention, that is, a radio resource allocation method for setting a D2D communication link between two cells. The radio resource allocation method can be applied to the fifth piece of UE 315, the sixth piece of UE 316 shown in FIG. 1.

The radio resource allocation method for setting a D2D communication link between pieces of UE present in two cells is similar to the radio resource allocation method for setting a D2D communication link in a single cell. However, pieces of UE that will perform D2D communication are present in different cells, and thus a process of exchanging load information about the respective cells is additionally performed.

In other words, in FIG. 1, the first base station 211 managing the first cell 210 where the fifth piece of UE 315 is present and the second base station 221 managing the second cell 220 where the sixth piece of UE 316 is present exchange load information about the respective cells. After that, each of the first base station 211 and the second base station 221 obtains load information about a cell managed by the base station itself and load information about a neighboring cell, and determines a radio resource allocation method on the basis of the obtained load information about the two cells (i.e., the first cell 210 and the second cell 220).

Specifically, to set a D2D communication link between the fifth piece of UE 315 and sixth piece of UE 316 present in different cells, the first and second base stations 211 and 221 allocate resources for the D2D communication link using the overlay-based radio resource allocation method only when loads of the first cell 210 and the second cell 220 are a predetermined reference or less, and allocate resources for the D2D communication link using the underlay-based radio resource allocation method in other cases.

For example, as shown in FIG. 4, when the loads of the first cell 210 and the second cell 220 are lower than the predetermined reference and there are available resources that are not resources allocated to pieces of UE performing cellular communication, the first and second base stations 211 and 221 allocate the available resources to the D2D communication link between the fifth piece of UE 315 and the sixth piece of UE 316.

On the other hand, as shown in FIG. 5, when the loads of the first cell 210 and/or the second cell 220 are higher than the predetermined reference and there are not sufficient available resources to be exclusively allocated to a D2D communication link, the first and second base stations 211 and 221 allocate some of resources allocated to pieces of UE that will perform cellular communication to the D2D communication link between the fifth piece of UE 315 and the sixth piece of UE 316.

A power control method for D2D communication used in connection with a radio resource allocation method as described above according to an example embodiment of the present invention will be described below.

The power control method for D2D communication according to an example embodiment of the present invention can be used when the underlay-based resource allocation method of allocating resources so that at least one piece of cellular communication UE performing cellular communication and pieces of D2D communication UE performing D2D communication share radio resources is used.

The power control method for D2D communication according to an example embodiment of the present invention recognizes a communication environment of pieces of D2D communication UE, and dynamically sets a maximum power threshold usable by the pieces of D2D communication UE using the communication environment. Here, a base station may consider locations of pieces of UE setting a D2D communication link in a cell, a density of pieces of cellular communication UE present around the pieces of UE setting the D2D communication link, etc., and for this purpose, may periodically find locations of pieces of UE.

The base station may find the locations of the pieces of UE using various known methods, and measure the locations of the pieces of UE using a method, for example, global positioning system (GPS) technology, time of arrival (TOA) technology, or time difference of arrival (TDOA).

After recognizing the communication environment of the pieces of D2D communication UE as described above, the base station sets the maximum power threshold to a low value if the pieces of UE included in the D2D communication link are present at a cell boundary, and the density of the pieces of cellular communication UE around the pieces of D2D communication UE is high.

On the other hand, the base station sets the maximum power threshold to a high value when the pieces of UE included in the D2D communication link are present at the center of the cell, and the density of the pieces of cellular communication UE around the pieces of D2D communication UE is low.

In other words, in the power control method for D2D communication according to an example embodiment of the present invention, a base station dynamically sets a range of controlled power in consideration of locations of pieces of UE included in a D2D communication link and the number of pieces of cellular communication UE present around the pieces of D2D communication UE, thereby minimizing interference between the pieces of D2D communication UE and the pieces of cellular communication UE and improving overall efficiency of a system.

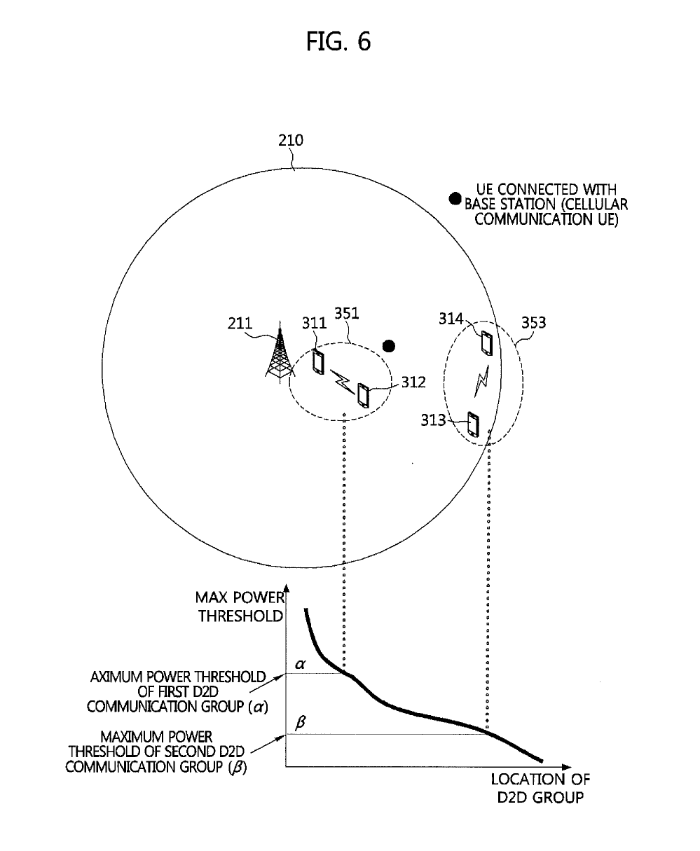

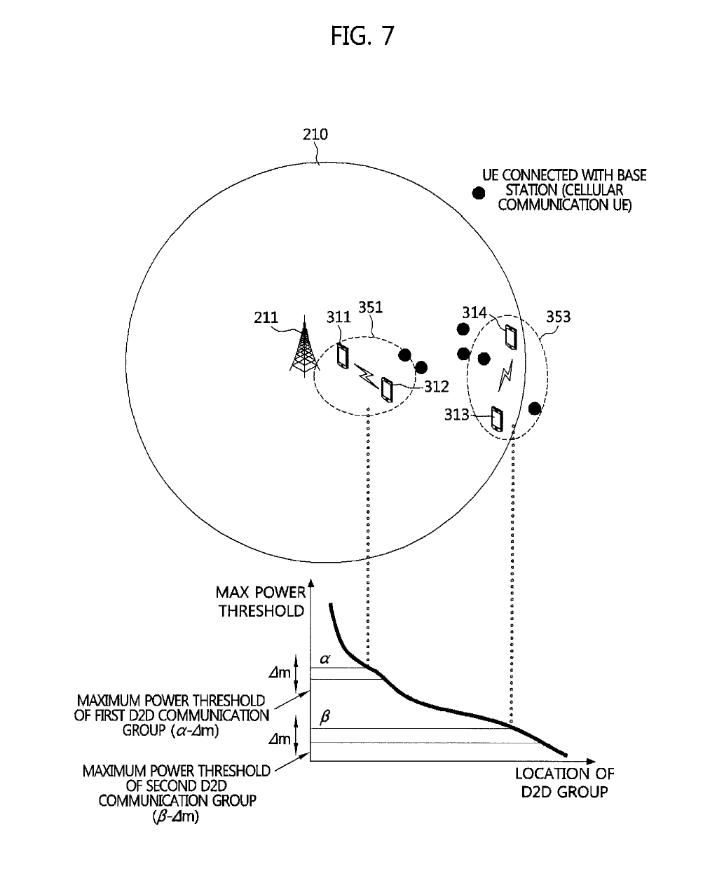

FIG. 6 and FIG. 7 are conceptual diagrams illustrating a power control method for D2D communication according to an example embodiment of the present invention. FIG. 6 illustrates a method of setting a maximum power threshold according to locations of pieces of D2D communication UE when a density of pieces of cellular communication UE around the pieces of D2D communication UE is low, and FIG. 7 illustrates a change in a maximum power threshold according to locations of pieces of D2D communication UE when a density of pieces of cellular communication UE around the pieces of D2D communication UE is high.

First, FIG. 6 illustrates an example in which a first piece of UE 311 and a second piece of UE 312 setting a D2D communication link (a first D2D communication group 351) are present at the center of a first cell 210, a third piece of UE 313 and a fourth piece of UE 314 setting a D2D communication link (a second D2D communication group 353) are present at a boundary of the first cell 210, and the number of pieces of cellular communication UE performing communication via a first base station 211 around each of the first D2D communication group 351 and the second D2D communication group 353 is lower than a predetermined reference (i.e., a density of the pieces of cellular communication UE is lower than the predetermined reference).

In a communication environment as shown in FIG. 6, the first base station 211 sets a maximum power threshold of the first D2D communication group 351 present at the center of the first cell 210 to a first power threshold cc that is a high value, and a maximum power threshold of the second D2D communication group 353 to a second power threshold 13 that is a low value.

Meanwhile, FIG. 7 illustrates an example in which the first piece of UE 311 and the second piece of UE 312 setting a D2D communication link (the first D2D communication group 351) are present at the center of the first cell 210, the third piece of UE 313 and the fourth piece of UE 314 setting a D2D communication link (the second D2D communication group 353) are present at the boundary of the first cell 210, and the number of pieces of cellular communication UE performing communication via the first base station 211 around the first D2D communication group 351 and the second D2D communication group 353 is higher than the predetermined reference (i.e., a density of the pieces of cellular communication UE is higher than the predetermined reference).

When the density of the pieces of cellular communication UE present around the pieces of D2D communication UE is high as illustrated in FIG. 7, the first base station 211 adjusts a maximum power threshold set for each D2D communication group using Am that is a UE density margin. For example, the first base station 211 changes the maximum power threshold of the first D2D communication group 351 present at the center of the first cell 210 and having the high density of the pieces of cellular communication UE to a value obtained by subtracting the UE density margin Δm from the previously set first power threshold α (α−Δm), and changes the maximum power threshold of the second D2D communication group 353 present at the boundary of the first cell 210 and having the high density of the pieces of cellular communication UE to a value obtained by subtracting the UE density margin Δm from the previously set second power threshold β (β−Δm).

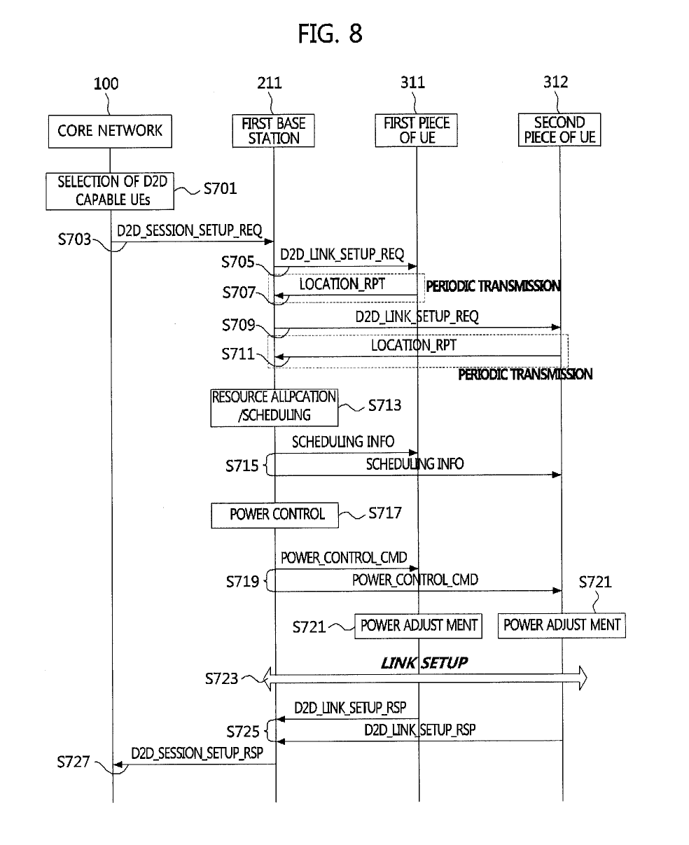

FIG. 8 is a flowchart illustrating a procedure for performing resource allocation and power control for D2D communication according to an example embodiment of the present invention.

FIG. 8 illustrates an example of a procedure carried out among a core network 100, a first base station 211, a first piece of UE 311, and a second piece of UE 312 to perform resource allocation and power control for D2D communication between the first piece of UE 311 and the second piece of UE 312 present in a first cell 210.

Referring to FIG. 8, first, the core network 100 selects the first piece of UE 311 and the second piece of UE 312 that will perform D2D communication (S701), and then transmits a D2D session setup request message D2D_Session_Setup_Req that requests setup of a D2D session between the selected first piece of UE 311 and second piece of UE 312 to the first base station 211 that is a base station of the cell where the first piece of UE 311 and the second piece of UE 312 are present (S703). Here, the core network 100 may be, for example, an MME and/or a serving/PDN-gateway, and may include IP addresses of the first and second pieces of UE 311 and 312 in the D2D session setup request message to specify the first and second pieces of UE 311 and 312 and transmit the D2D session setup request message to the first base station 211.

In response to the D2D session setup request message D2D_Session_Setup_Req received from the core network 100, the first base station 211 transmits a D2D communication link setup request message D2D_Link_Setup_Req requesting setup of a D2D communication link to the first piece of UE 311 (S705), and the first piece of UE 311 transmits a location report message Location_Rpt including location information to the first base station 211 in response to the D2D communication link setup request message (S707). Here, the first piece of UE 311 may transmit location information to the first base station 211 at predetermined periods.

Also, the first base station 211 transmits the D2D communication link setup request message D2D_Link_Setup_Req requesting setup of a D2D communication link to the second piece of UE 312 as well (S709), and the second piece of UE 312 transmits a location report message Location_Rpt including location information to the first base station 211 in response to the D2D communication link setup request message (S711). Here, the second piece of UE 312 may transmit location information to the first base station 211 at predetermined periods. Step S705 and step S709 may be performed at the same time, or step S709 may be performed before step S705.

Subsequently, the first base station 211 selects any one of the overlay-based radio resource allocation method and the underlay-based radio resource allocation method in consideration of the location information received from each of the first piece of UE 311 and the second piece of UE 312 and a load of the cell, and then allocates resources for D2D communication between the first piece of UE 311 and the second piece of UE 312 using the selected radio resource allocation method (S713). Here, the first base station 211 uses the same radio resource allocation methods as illustrated in FIG. 3 to FIG. 5, and the detailed description of the radio resource allocation methods will be omitted.

After performing resource allocation for a D2D communication link between the first and second pieces of UE 311 and 312 as mentioned above, the first base station 211 transmits scheduling information Scheduling Info including resource allocation information to the first and second pieces of UE 311 and 312 (S715).

The first base station 211 determines a density of pieces of cellular communication UE around the first and second pieces of UE 311 and 312 using the location information about the first and second pieces of UE 311 and 312 received in step S707 and step S711 and location information about pieces of cellular communication UE present in the cell, performs power control of the first and second pieces of UE 311 and 312 using the locations of the first and second pieces of UE 311 and 312 and the density of the pieces of cellular communication UE (S717), and then transmits power control information Power_Control_Cmd to the first and second pieces of UE 311 and 312 (S719). At this time, the first base station 211 may set maximum power thresholds of the first and second pieces of UE 311 and 312 using the locations of the first and second pieces of UE 311 and 312 and the density of the pieces of cellular communication UE, and transmit the set maximum power thresholds to the first and second pieces of UE 311 and 312. The first base station 211 uses the same power control method as illustrated in FIG. 6 and FIG. 7, and the detailed description of the power control method will be omitted.

On the basis of the scheduling information received in step S715 and the power control information received in step S719, the first and second pieces of UE 311 and 312 check radio resources to be used for D2D communication and adjust transmission power (S721).

Subsequently, the first and second pieces of UE 311 and 312 set a D2D communication link between themselves (S723), and transmit D2D communication link setup response messages D2D_Link_Setup_Rsp denoting completion of D2D communication link setup to the first base station 211 (S725).

In response to the D2D communication link setup response messages D2D_Link_Setup_Rsp received from the first and second pieces of UE 311 and 312, the first base station 211 transmits a D2D session setup response message D2D_Session_Setup_Rsp denoting completion of session setup between the first and second pieces of UE 311 and 312 to the core network 100 (S727).

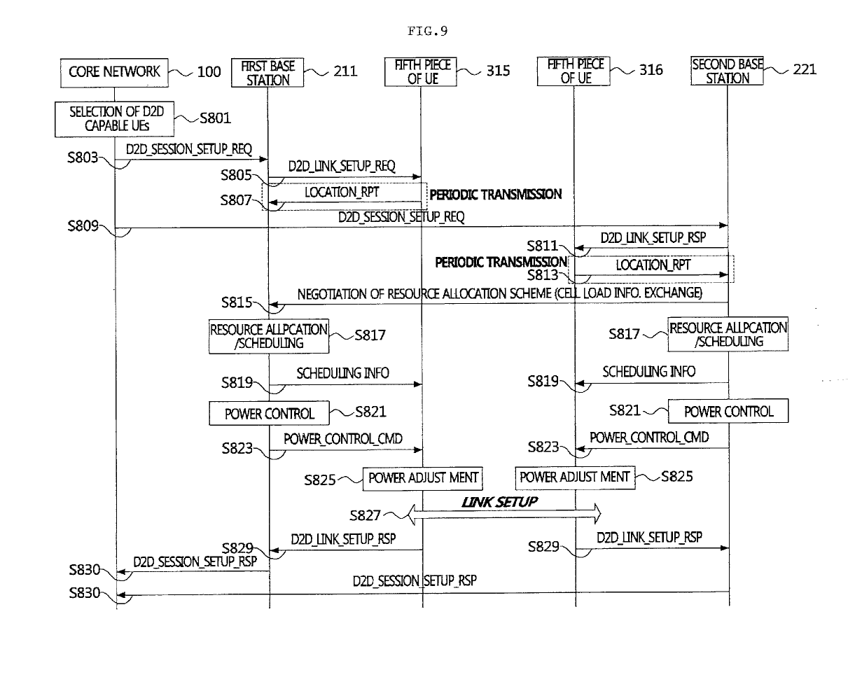

FIG. 9 is a flowchart illustrating a procedure for performing resource allocation and power control for D2D communication according to another example embodiment of the present invention, and more specifically, a procedure for performing resource allocation and power control for D2D communication between pieces of UE that are present in two cells, respectively.

FIG. 9 illustrates an example of a procedure carried out among a core network 100, a first base station 211, a second base station 221, a fifth piece of UE 315, and a sixth piece of UE 316 to perform resource allocation and power control for D2D communication between the fifth piece of UE 315 present in a first cell 210 and the sixth piece of UE 316 present in a second cell 220.

Referring to FIG. 9, first, the core network 100 selects the fifth piece of UE 315 and the sixth piece of UE 316 that will perform D2D communication (S801), and then transmits a D2D session setup request message D2D_Session_Setup_Req that requests setup of a D2D session between the selected fifth piece of UE 315 and sixth piece of UE 316 to the first base station 211 that manages the first cell 210 where the fifth piece of UE 315 is present (S803).

In response to the D2D session setup request message D2D_Session_Setup_Req received from the core network 100, the first base station 211 transmits a D2D communication link setup request message D2D_Link_Setup_Req requesting setup of a D2D communication link to the fifth piece of UE 315 (S805), and the fifth piece of UE 315 transmits a location report message Location_Rpt including location information to the first base station 211 in response to the D2D communication link setup request message (S807). Here, the fifth piece of UE 315 may transmit location information to the first base station 211 at predetermined periods.

Also, the core network 100 transmits the D2D session setup request message D2D_Session_Setup_Req that requests setup of a D2D session between the selected fifth piece of UE 315 and sixth piece of UE 316 to the second base station 221 that manages the second cell 220 where the sixth piece of UE 316 is present (S809).

In response to the D2D session setup request message D2D_Session_Setup_Req received from the core network 100, the second base station 221 transmits a D2D communication link setup request message D2D_Link_Setup_Req requesting setup of a D2D communication link to the sixth piece of UE 316 (S811), and the sixth piece of UE 316 transmits a location report message Location_Rpt including location information to the second base station 221 in response to the D2D communication link setup request message (S813). Here, the sixth piece of UE 316 may transmit location information to the second base station 221 at predetermined periods.

In FIG. 9, the core network 100 may be, for example, an MME and/or a serving/PDN-gateway, and may include IP addresses of the fifth and sixth pieces of UE 315 and 316 in the D2D session setup request message to specify the fifth piece of UE 315 and the sixth piece of UE 316 and transmit the D2D session setup request message to the first and second base stations 211 and 221. Also, in FIG. 9, step S803 and step S809 may be performed at the same time, or step S809 may be performed before step S803. According to the sequence, a sequence of performing step S805, step S807, step S811 and step S813 may be changed.

Subsequently, the first base station 211 and the second base station 221 exchange load information about the cells respectively managed by themselves (S815). At this time, the first base station 211 and the second base station 221 may negotiate with each other for a radio resource allocation method on the basis of the load information about the counterpart cells received from the counterpart base stations, the load information about the cells managed by themselves, and the location information about the fifth piece of UE 315 and the sixth piece of UE 316, and through the negotiation, may determine any one of the overlay-based radio resource allocation method and the underlay-based radio resource allocation method as a radio resource allocation method for a D2D communication link between the fifth piece of UE 315 and the sixth piece of UE 316.

Subsequently, the first base station 211 and the second base station 221 allocate resources for a D2D communication link between the fifth piece of UE 315 and the sixth piece of UE 316 on the basis of the determined radio resource allocation method (S817).

As described above, each of the first base station 211 and the second base station 221 allocates resources for a D2D communication link, and then transmits scheduling information including resource allocation information to a piece of UE present in its own cell (S819).

The first base station 211 and the second base station 221 each determine densities of pieces of cellular communication UE around the fifth and sixth pieces of UE 315 and 316 using the location information about the fifth and sixth pieces of UE 315 and 316 received in step S807 and step S813 and location information about pieces of cellular communication UE present in the respective cells, perform power control of the fifth and sixth pieces of UE 315 and 316 using the locations of the fifth and sixth pieces of UE 315 and 316 and the densities of pieces of cellular communication UE (S821), and then transmit power control information Power_Control_Cmd to the fifth and sixth pieces of UE 315 and 316 (S823).

At this time, the first base station 211 may set a maximum power threshold of the fifth piece of UE 315 using the location of the fifth piece of UE 315 and a density of pieces of cellular communication UE and transmit the set maximum power threshold to the fifth piece of UE 315, and the second base station 221 may set a maximum power threshold of the sixth piece of UE 316 using the location of the sixth piece of UE 316 and a density of pieces of cellular communication UE and transmit the set maximum power threshold to the sixth piece of UE 316. The first and second base stations 211 and 221 use the same power control method as illustrated in FIG. 6 and FIG. 7, and the detailed description of the power control method will be omitted.

On the basis of the scheduling information received in step S819 and the power control information received in step S823, the fifth and sixth pieces of UE 315 and 316 check radio resources to be used for D2D communication and adjust transmission power (S825).

Subsequently, the fifth and sixth pieces of UE 315 and 316 set a D2D communication link between themselves (S827), and transmit D2D communication link setup response messages D2D_Link_Setup_Rsp denoting completion of D2D communication link setup to the first base station 211 and the second base station 221, respectively (S829).

In response to the D2D communication link setup response messages D2D_Link_Setup_Rsp respectively received from the fifth and sixth pieces of UE 315 and 316, the first base station 211 and the second base station 221 transmit D2D session setup response messages D2D_Session_Setup_Rsp denoting completion of session setup between the fifth and sixth pieces of UE 315 and 316 to the core network 100 (S830).

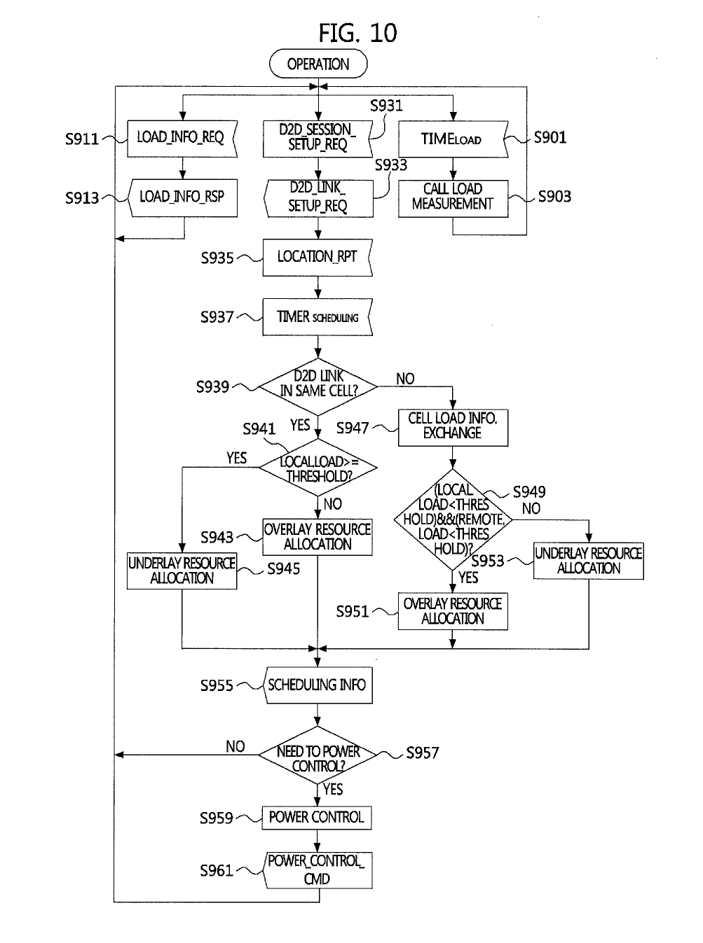

FIG. 10 is a flowchart illustrating operation of a base station that performs a resource allocation and power control method for D2D communication according to example embodiments of the present invention.

Referring to FIG. 10, operation of a base station that performs resource allocation and power control for D2D communication according to example embodiments of the present invention may include a procedure of measuring a load of a cell, a procedure of processing a load information exchange request for setting a D2D communication link provided from a neighboring cell, and a procedure of processing a D2D communication link setup request provided from a core network.

First, the procedure of measuring a load of a cell includes a process in which, when it becomes a predetermined load measurement period Time_{load} (S901), a base station measures a load of a cell (S903). Here, the base station may determine usage of radio resources at the predetermined load measurement periods, thereby measuring the load of the cell.

The procedure of processing a load information exchange request for setting a D2D communication link provided from a neighboring cell includes a process in which, when a load information exchange request Load_Info_Req for setting a D2D communication link is received from a neighboring cell (S911), the base station transmits a load information response message Load_Info_Rsp including acquired load measurement information to the neighboring cell in response to the load information request message Load_Info_Req (S913).

The procedure of processing a D2D communication link setup request provided from a core network is as follows.

When a D2D session setup request message D2D_Session_Setup_Req for pieces of UE that will perform D2D communication is received from a core network (S931), the base station transmits a D2D communication link setup request message D2D_Link_Setup_Req requesting setup of a D2D communication link to the pieces of UE (S933).

Subsequently, the base station receives a location report message Location_Rpt including location information from the pieces of UE (S935). When it becomes a scheduling time point (S937), the base station determines whether a D2D communication link is set in a single cell (S939). At this time, the base station may determine whether a D2D communication link is set in a single cell on the basis of the location information received from the pieces of UE.

When it is determined in step S939 that a D2D communication link is set in a single cell, the base station determines whether a load Local.Load of the cell managed by the base station itself is a predetermined reference value or more (S941). When it is determined that the cell load Local.Load is not the predetermined reference value or more, the base station allocates resources for a D2D communication link using the overlay-based resource allocation method (S943).

On the other hand, when it is determined in step S941 that the cell load Local.Load is the predetermined reference value or more, the base station allocates resources for a D2D communication link using the underlay-based resource allocation method (S945).

Meanwhile, when it is determined in step S939 that a D2D communication link is set between two cells, the base station exchanges load information about the cells with a base station of a neighboring cell related to setup of a D2D communication link (S945), and compares its own cell load and a load of the neighboring cell with the reference value (S947).

When the comparison result of step S947 is that both the cell load of the base station and the load of the neighboring cell are less than the threshold, the base station allocates resources for a D2D communication link using the overlay-based resource allocation method (S951). On the other hand, when the comparison result of step S947 is that any one of the cell load of the base station and the load of the neighboring cell is the threshold or more, the base station allocates resources for a D2D communication link using the underlay-based resource allocation method (S953).

After allocating resources for a D2D communication link by performing step S943, S945, S951 or S953, the base station transmits scheduling information Scheduling Info including resource allocation information to the pieces of D2D communication UE (S955).

Subsequently, the base station determines whether the pieces of D2D communication UE are in need of transmission power control (S957). When the pieces of D2D communication UE are in need of transmission power control, the base station performs power control (S959), and then transmits power control information Power_Control_Cmd to the pieces of D2D communication UE (S961).

In the above-described control methods for D2D communication, resources for a D2D communication link are allocated by selectively using the overlay-based resource allocation method or the underlay-based resource allocation method according to the load of a cell. In addition, to set a D2D communication link between pieces of UE present in two different cells, load information about the respective cells is exchanged, and a resource allocation method is selected on the basis of the exchanged load information about the respective cells.

Furthermore, in consideration of locations of pieces of D2D communication UE performing D2D communication and a density of pieces of cellular communication UE present around the pieces of D2D communication UE, a maximum power threshold is dynamically set.

Consequently, it is possible to improve the radio resource use efficiency of a mobile communication system, and minimize interference between D2D communication UE and cellular communication UE.

While example embodiments of the present invention and their advantages have been described in detail, it should be understood that various changes, substitutions and alterations may be made herein without departing from the scope of the invention.

What is claimed is:

1. A control method for device-to-device (D2D) communication performed in a base station, comprising:
measuring a load of a cell;
receiving location information about each piece of user equipment (UE) from a plurality of pieces of UE;
selecting any one of an overlay-based resource allocation method and an underlay-based resource allocation method on the basis of the measured cell load and the location information about the respective pieces of UE; and
allocating resources for D2D communication on the basis of the selected resource allocation method.

2. The control method for D2D communication of claim 1, wherein receiving location information about each piece of UE from the plurality of pieces of UE includes:
transmitting a message requesting setup of a D2D communication link to the plurality of pieces of UE; and
receiving the location information from the respective pieces of UE receiving the message requesting setup of a D2D communication link.

3. The control method for D2D communication of claim 1, wherein selecting any one resource allocation method includes:
determining whether pieces of UE between which a D2D communication link will be set among the plurality of pieces of UE are present in the same cell on the basis of the received location information about the respective pieces of UE; and
selecting the underlay-based resource allocation method when the pieces of UE between which a D2D communication link will be set are present in the same cell, and the measured cell load is a predetermined reference value or more.

4. The control method for D2D communication of claim 3, wherein selecting any one resource allocation method further includes selecting the overlay-based resource allocation method when the pieces of UE between which a D2D communication link will be set are present in the same cell, and the measured cell load is less than the predetermined reference value.

5. The control method for D2D communication of claim 1, wherein selecting any one resource allocation method includes:
determining whether pieces of UE between which a D2D communication link will be set among the plurality of pieces of UE are present in the same cell on the basis of the received location information about the respective pieces of UE;
when the pieces of UE between which a D2D communication link will be set are respectively present in a first cell and a second cell different from each other, exchanging, at a first base station managing the first cell and a second base station managing the second cell, load information about the first and second cells managed by the first and second base stations; and
selecting, at each of first and second base stations, the overlay-based resource allocation method when the loads of the first and second cells are less than a predetermined reference value.

6. The control method for D2D communication of claim 5, wherein selecting any one resource allocation method further includes selecting, at each of first and second base stations, the underlay-based resource allocation method when any one of the loads of the first and second cells is the predetermined reference value or more.

7. A control method for device-to-device (D2D) communication between a first piece of user equipment (UE) present in a first cell and a second piece of UE present in a second cell, comprising:
measuring, at each of a first base station managing the first cell and a second base station managing the second cell, a cell load of the base station;
exchanging, at the first base station and the second base station, the cell load information for D2D communication;
selecting, at each of the first base station and the second base station, any one of an overlay-based resource allocation method and an underlay-based resource allocation method on the basis of the measured cell load of the base station; and
allocating, at each of the first base station and the second base station, resources on the basis of the selected resource allocation method.

8. The control method for D2D communication of claim 7, wherein selecting any one resource allocation method includes selecting, at each of the first base station and the second base station, the overlay-based resource allocation method when the loads of the first and second cells are less than a predetermined reference value, and selecting, at each of the first base station and the second base station, the underlay-based resource allocation method when any one of the loads of the first and second cells is the predetermined reference value or more.

9. A control method for device-to-device (D2D) communication performed in a base station, comprising:
receiving location information about each piece of user equipment (UE) from a plurality of pieces of UE;
performing power control for D2D communication on the basis of the location information about the respective pieces of UE; and
transmitting power control information to pieces of D2D communication UE that are pieces of UE between which a D2D communication link will be set among the plurality of pieces of UE.

10. The control method for D2D communication of claim 9, wherein performing power control for D2D communication includes differently setting a maximum power threshold according to a distance between locations of the pieces of D2D communication UE and the base station on the basis of the received location information about the respective pieces of UE.

11. The control method for D2D communication of claim 10, wherein performing power control for D2D communication further includes assigning a higher maximum power threshold to pieces of first D2D communication UE whose distance from the base station is a first distance than pieces of second D2D communication UE whose distance from the base station is a second distance greater than the first distance.

12. The control method for D2D communication of claim 9, wherein performing power control for D2D communication includes differently setting a maximum power threshold according to a density of pieces of cellular communication UE present within a predetermined area centered on the locations of the pieces of D2D communication UE on the basis of the received location information about the respective pieces of UE.

13. The control method for D2D communication of claim 12, wherein performing power control for D2D communication further includes assigning a lower maximum power threshold to pieces of first D2D communication UE whose density is a first density than pieces of second D2D communication UE whose density is a second density lower than the first density.

14. The control method for D2D communication of claim 9, wherein performing power control for D2D communication includes differently setting a maximum power threshold according to a distance between the locations of the pieces of D2D communication UE and the base station, and a density of pieces of cellular communication UE present within a predetermined area centered on the locations of the pieces of D2D communication UE on the basis of the received location information about the respective pieces of UE.
